(19) United States
(12) Patent Application Publication
(10) Pub. No.: US 2014/0111115 A1
(43) Pub. Date: Apr. 24, 2014

(54) DISPLAY DEVICES HAVING NON-UNIFORM SUB-PIXEL SPACING AND METHODS THEREFOR

(71) Applicant: MOTOROLA MOBILITY LLC, Libertyville, IL (US)

(72) Inventors: XiaoPing Bai, Lake Zurich, IL (US); Weihong Zhang, Kildeer, IL (US); Zhiming Zhuang, Kildeer, IL (US)

(73) Assignee: MOTOROLA MOBILITY LLC, Libertyville, IL (US)

(21) Appl. No.: 13/657,322

(22) Filed: Oct. 22, 2012

(51) Int. Cl. H05B 33/12; H01J 9/42

(52) U.S. Cl. 315/312; 445/3

(57) ABSTRACT

A display device (301) includes a plurality of pixels (302,309,310,315,330,331,332) operable to emit or modulate light. Each pixel of the plurality of pixels comprising a plurality of subpixels (303,304,305,306,307,308,311,312,313,333,334,335). To create an asymmetrical spacing across the display module, every pixel can at least two subpixels spaced apart from each other by a predetermined distance (336), while one or more pixels, which form a subportion of the plurality of pixels, each comprise at least one subpixel spaced apart from at least one adjacent subpixel by another predetermined distance (337), where the other predefined spacing is greater than the predefined spacing.

### BACKGROUND

1. Technical Field

This invention relates generally to display devices, and more particularly to pixelated display devices.

2. Background Art

Display devices, such as those used in mobile devices including mobile phones, tablets, smart phones, laptop computers, palmtop computers, and the like, are devices that emit and modulate light to present images and data to a user. Most display devices use the same essential technology. A large number of “pixels” are used to emit and/or modulate light. Each pixel is an addressable element that can be controlled to emit a predetermined color of light. The light from each pixel gets synthesized with that from other pixels to form an image, words, or data.

Manufacturers of devices incorporating display devices market these devices, in part, upon the technical specifications of the display. However, limitations in pixel manufacturing technology can place constraints upon the technical specifications that can be offered. Accordingly, it would be advantageous to have an improved display device that offered technical specifications that were more appealing to potential users of electronic devices having the improved display device disposed therein.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a prior art electronic device and its prior art display device.

FIG. 2 illustrates a prior art display device and examples of prior art pixel configurations.

FIG. 3 illustrates an exploded view of one explanatory embodiment of a display device configured in accordance with embodiments of the invention.

FIG. 4 illustrates one explanatory placement machine suitable for constructing display devices configured in accordance with one or more embodiments or methods of the invention.

FIG. 5 illustrates one explanatory display device configured in accordance with embodiments of the invention.

FIG. 6 illustrates another explanatory display device configured in accordance with embodiments of the invention.

FIG. 7 illustrates another explanatory display device configured in accordance with embodiments of the invention.

FIG. 8 illustrates another explanatory display device configured in accordance with embodiments of the invention.

FIG. 9 illustrates one explanatory technical specification associated with one or more explanatory display devices configured in accordance with one or more embodiments of the invention.

FIG. 10 illustrates one explanatory method of manufacturing one explanatory display device configured in accordance with one or more embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF EMBODIMENTS OF THE INVENTION

Before describing in detail embodiments that are in accordance with the present invention, it should be observed that the embodiments reside primarily in combinations of method steps and apparatus components related to display devices having non-uniform pixel and/or subpixel spacing configured in accordance with embodiments of the invention. Any process descriptions or blocks in flow charts should be understood as representing modules, segments, or portions of code which include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of controlling a placement machine to place pixels and/or sub-pixels with non-uniform spacing as described herein. As such, these functions may be interpreted as steps of a method to perform the steps of manufacturing display devices as described below. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the invention provide an improved display module comprising a plurality of pixels operable to emit or modulate light. In one embodiment, each pixel of the plurality of pixels comprises a plurality of subpixels. For example, in one embodiment each pixel can include a red subpixel, a green subpixel, and a blue subpixel. In another embodiment, each pixel can include a red subpixel, a green subpixel, a blue subpixel, and a yellow subpixel. In yet another embodiment, each pixel can include subpixels configured to independently modulate, rather than emit, light.

Rather than having a uniform spacing between subpixels as in prior art designs, in one embodiment the subpixels are arranged such that a non-uniform subpixel spacing exists across a length and width of the display. For example, in one embodiment every pixel comprises at least two subpixels that are spaced apart from each other by a predefined spacing. However, one or more pixels that form a subportion of the plurality of pixels disposed along the display each comprise at least one subpixel that is spaced apart from at least one adjacent subpixel by another predefined spacing. Where the second predefined spacing is greater than the first predefined spacing, some pixels will have subpixels that are uniformly spaced and some other subpixels will include at least one subpixel having a different, greater spacing than the uniform one. As a result of this, the overall spacing of the subpixels across the display will be non-uniform.

The non-uniformity of the present invention offers numerous advantages over prior art designs. Using a smart phone as an example, the design of a particular smart phone requires a display that can fit into a housing having dimensions that are frequently pre-defined. For example, a particular model of phone may have a housing that is consistent in form factor across many generations of the device. The display designer thus receives a predetermined set of dimensional constraints with which to work.

At the same time, rules governing the way that such devices are marketed can affect the way that potential users perceive a device in the marketplace. Illustrating by example, display dimensions are generally rounded up in tenth of an inch increments. Accordingly, a display device having a 4.95 inch diagonal dimension can properly be marketed as a “5-inch display” in accordance with commonly accepted practices because, rounding to the next tenth of an inch, 4.95 rounds to 5.0. By contrast, a display having a diagonal dimension that is just one-hundreth of an inch less, i.e., 4.949 inches, cannot be marketed as a 5-inch display.

To provide a mechanism to enable small increases in the diagonal dimension, while still allowing the display to fit within a predetermined mechanical constraints associated with a particular housing, embodiments of the present invention provide a method for asymmetrically spacing only some of the subpixels of a display while providing a consistent spacing of other subpixels. This asymmetric spacing can provide just the difference needed to take the display's diagonal dimensions to the next marketable level. This minor technical difference can result in vastly increased sales due to the new perception the technical difference offers in the market.

To better explain the above, consider the following example: Presume that a particular smart phone has a housing that will only permit a display device having a diagonal dimension of 4.975 inches. Employing a uniform spacing on state of the art placement equipment, a display having 720 columns of pixels and 1280 rows of pixels has a diagonal dimension of 4.944 inches. In accordance with the commonly accepted marketing practices described above, this display cannot be marketed as a “5-inch display” because, rounding to the nearest tenth of an inch, it is only a 4.9-inch display. Using the next available prior art design, which employs slightly larger uniform pixel spacing, the diagonal dimension of the display increases to 4.987 inches. While this display device can easily be marketed as a 5-inch display, it cannot be used in the mechanical housing because the diagonal dimension exceeds the mechanical constraint of 4.975 inches. However, by using the non-uniform spacing of only some of the subpixels of the display as described below, a designer can increase the diagonal dimension to, for example, 4.97 inches without any visible artifacts. This display size can both fit within the housing and be marketed as a 5-inch display in the marketplace.

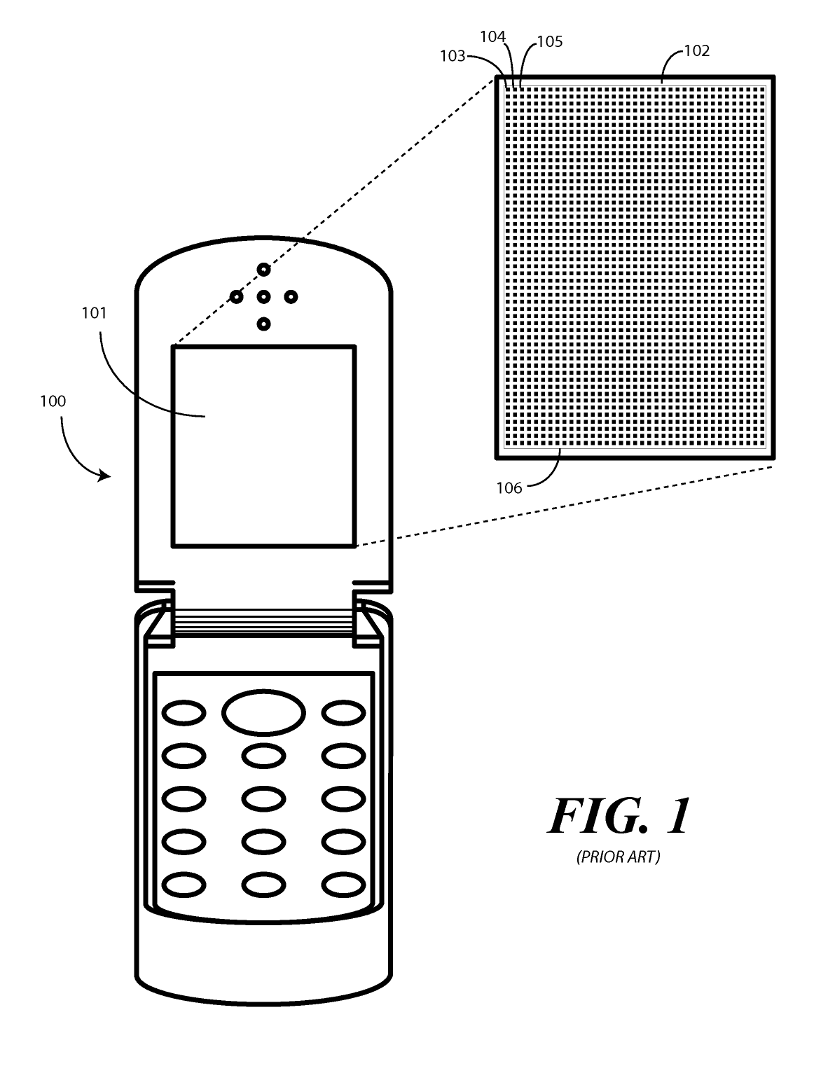

Turning now to FIG. 1, illustrated therein is an example of a prior art electronic device 100 having a display 101 for presenting information to a user. A display module 102 of the display is shown in an exploded view. The display module 102 has a plurality of pixels, e.g., pixels 103,104,105. The pixels 103,104,105 can emit light, or alternatively can modulate light emitted from light sources disposed beneath the pixels 103,104,105. Each and every one of the pixels 103,104,105 is uniformly spaced across the display area 106 of the display module 102. Prior art devices do this to prevent the creation of visible artifacts that can occur when light from adjacent pixels constructively and/or destructively interferes with light from other pixels.

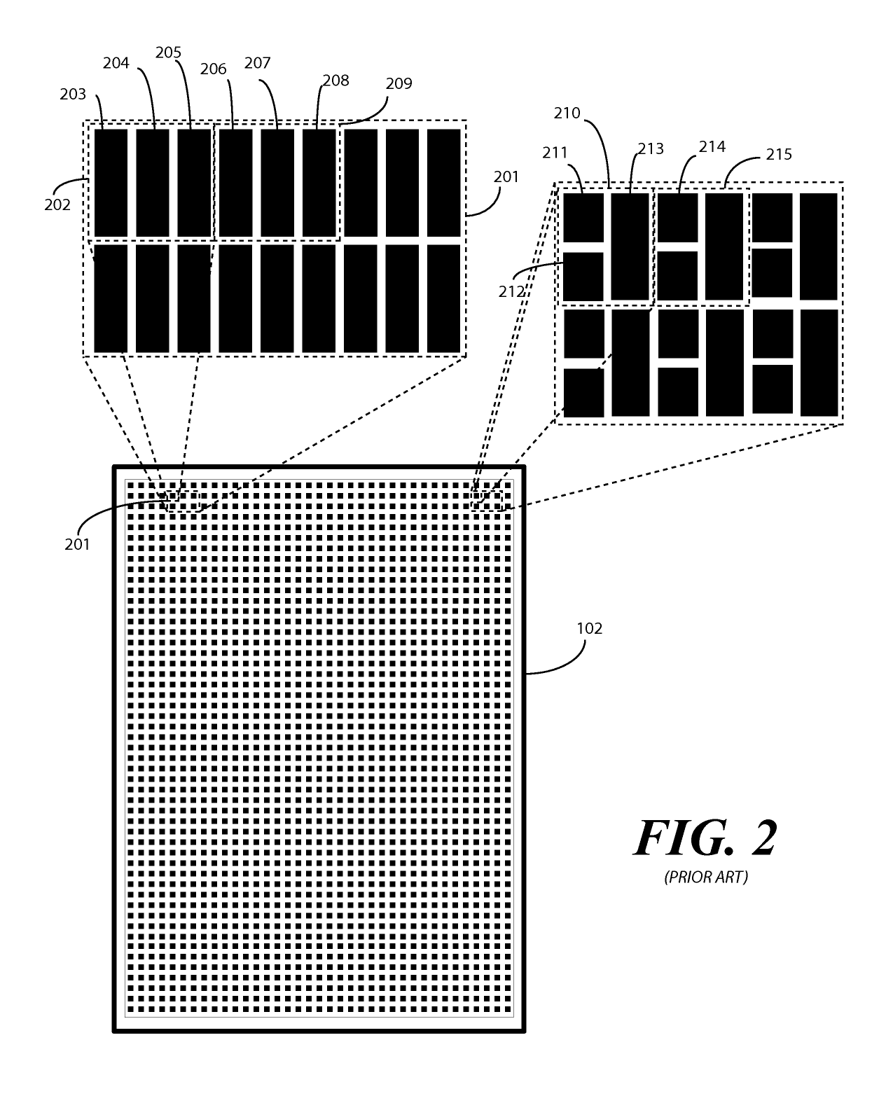

Turning now to FIG. 2, illustrated therein is a closer view of the display module 102. As shown in FIG. 2, in this prior art display module 102, each pixel is formed from a group of subpixels. Subpixels are frequently used to construct a given pixel. As one example, to present color images, each pixel must have three subpixels. A first subpixel has a red filter, while a second has a blue filter. A third subpixel has a green filter. These subpixels then work together to produce various colors of light by controlling the amount of red, green, and blue light emitted from a given pixel, respectively.

Illustrating by example, pixel group 201 contains a group of six pixels. Each pixel, e.g., pixel 202, comprises three subpixels 203,204,205. As with the pixels (103,104,105) of the display module 102, each of the subpixels 203,204,205 is uniformly spaced from each other subpixel to avoid the introduction of visual artifacts. Further, subpixels from adjacent pixels are evenly spaced as well. Thus, as shown in FIG. 2, subpixels 203,204,205, each forming a subpixel of pixel 202, are separated from each other by a predetermined, constant distance. Similarly, subpixels 206,207,208 of pixel 209 are also separated from each other by the predetermined, constant distance. Moreover, subpixel 206 of pixel 209 is separated from subpixel 205 of pixel 202 by the same predetermined, constant distance that subpixels 203,204,205 and subpixels 206,207,208 are spaced from each other, respectively. This uniformity is consistently found in prior art designs to avoid the introduction of visible artifacts.

To illustrate that the subpixels do not have to be a consistent size, illustrative pixel 210 is made from subpixels 211,212,213 that have differing sizes. In this illustrative prior art display module 102, subpixel 213 is a blue subpixel, while subpixel 211 is a red subpixel and subpixel 212 is a green subpixel. Sometimes larger blue subpixels will be used because blue is not as easily perceived by the human eye. Accordingly, pixel 210 has one subpixel 213 that is larger than the others.

Even where this is the case, the subpixels 211,212,213 are uniformly spaced apart. For example, subpixel 211 and subpixel 212 are spaced apart vertically by the same predetermined distance that subpixel 213 is separated horizontally from both subpixels 211,212, respectively. Further, the distance between subpixel 214, which belongs to pixel 215, is the same as that between subpixel 211 and subpixel 213. This provides a uniform spacing between all pixels and avoids visual artifacts.

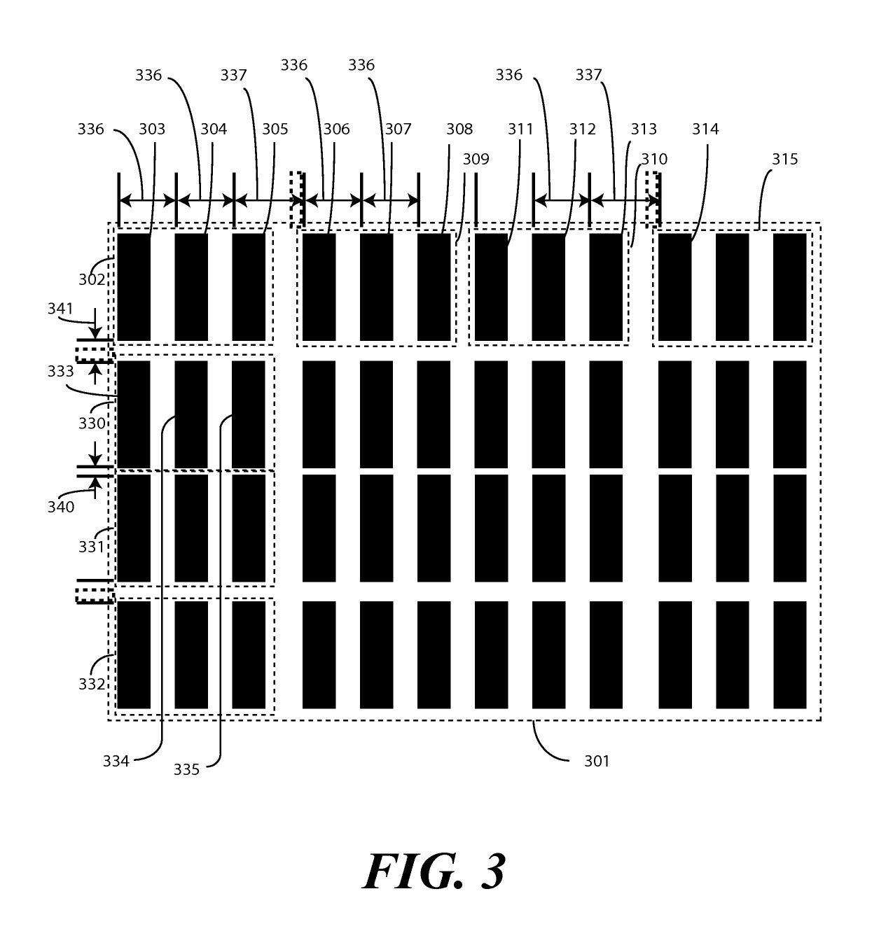

Turning now to FIG. 3, illustrated therein is a display device 301 configured in accordance with one or more embodiments of the present invention. The inventors have invented a method of manufacturing display devices with non-uniform, asymmetric subpixel spacing that does not result in any visual artifacts but that allows one or more major dimensions of the display device 301 to be increased by a predetermined amount. Asymmetric spacing without the introduction of visual artifacts is a novel benefit offered by embodiments of the invention and is provided by spacing some of the subpixels differently than other of the subpixels. This allows the major dimension to increase by a sufficient amount to “round-up” to the next marketably distinct dimension while still fitting within a given housing dimension and without creating any visual artifacts.

As shown in FIG. 3, the display device 301 comprises a plurality of pixels. The pixels are grouped in rows and columns. In one embodiment that will be used for explanatory purposes, the plurality of pixels define a display device 301 having 720 rows and 1280 columns. Accordingly, the plurality of pixels defines a 720 pixel by 1280 pixel display module.

Illustrating by example, pixels 302,309,310,315,330,331,332 are shown. Each of the pixels 302,309,310,315,330,331,332 comprises a plurality of subpixels. For instance, pixel 302 comprises subpixels 303,304,305. Similarly, pixel 309 comprises subpixels 306,307,308. Pixel 310 comprises subpixels 311,312,313, while pixel 330 comprises subpixels 333,334,335, and so forth.

Each of the pixels 302,309,310,315,330,331,332 has at least two subpixels that are spaced apart from each other by a predetermined spacing. Illustrating by example, subpixel 303 and subpixel 304 are spaced apart from each other by a predetermined distance 336 or predefined spacing. Similarly, subpixel 304 is spaced apart from subpixel 305 by the predetermined distance 336 as well. Turning to pixel 309, subpixel 306 is spaced apart from subpixel 307 by the predetermined distance 336, as is subpixel 307 from subpixel 308. This continues for each pixel, as every pixel can be found to have at least two subpixels spaced apart from each other by the predetermined distance 336.

To provide the asymmetric, non-uniform spacing, one or more of the pixels, which collectively comprise a subportion of the total number of pixels on the display device 301, have at least one subpixel that is spaced apart from at least one adjacent subpixel by another predetermined distance or spacing that is greater than predetermined distance 336. For example, subpixel 305 is spaced apart from subpixel 306 by predetermined distance 337. Predetermined distance 337 is greater than predetermined distance 336. Similarly, subpixel 313 is spaced apart from subpixel 314 by predetermined distance 337 that is greater than predetermined distance 336 separating subpixel 312 from subpixel 313. Each pixel shown in FIG. 3 has at least one subpixel that is spaced apart from at least one adjacent subpixel by this greater distance.

Looking at the spacing between the rows, adjacent subpixels, e.g., subpixels 333,339, are spaced apart by predetermined distance 340. This predetermined distance 340 can be the same as predetermined distance 336. However in one embodiment, predetermined distance 340 is less than predetermined distance 336. In another embodiment, predetermined distance 340 is greater than predetermined distance 336.

While some subpixels are spaced apart vertically by predetermined distance 340, others are spaced apart by predetermined distance 341, which is greater than predetermined distance 340. This predetermined distance 341 can be the same as predetermined distance 337. However in one embodiment, predetermined distance 341 is less than predetermined distance 337. In another embodiment, predetermined distance 341 is greater than predetermined distance 337.

In one embodiment, spacing is only provided across the horizontal. Said differently, some subpixels will be spaced horizontally apart by predetermined distance 336, while some will be spaced apart by predetermined distance 337. At the same time, each of the subpixels will be spaced vertically apart by a single predetermined distance, be it predetermined distance 340, predetermined distance 341, or another predetermined distance.

In another embodiment, spacing is only provided across the vertical. Said differently, some subpixels will be spaced vertically apart by predetermined distance 340, while some will be spaced apart by predetermined distance 341. At the same time, each of the subpixels will be spaced vertically apart by a single predetermined distance, be it predetermined distance 336, predetermined distance 337, or another predetermined distance.

In yet another embodiment, a combination of varied vertical and horizontal spacing will be used. Accordingly, spacing is provided across a combination of the horizontal and the vertical. Said differently, some subpixels will be spaced horizontally apart by predetermined distance 336, while some will be spaced horizontally apart by predetermined distance 337 or another predetermined distance. At the same time, some subpixels will be spaced vertically apart by predetermined distance 340, while others will be spaced vertically apart predetermined distance 341 or another predetermined distance. This “combination” asymmetrical spacing is illustratively shown in FIG. 3.

In one embodiment, the greater spacing, i.e., predetermined distance 337 or predetermined distance 341, is used to separate every other pixel of the plurality of pixels. For example, as shown in FIG. 3, pixel 302 has a subpixel 305 spaced apart by predetermined distance 337 from a subpixel 306 of pixel 309. Similarly, pixel 310 has a subpixel 313 that is spaced apart from subpixel 314 of pixel 315 by predetermined distance 337. By contrast, pixel 309 has a subpixel 308 spaced apart from subpixel 311 of pixel 310 by predetermined distance 336. Accordingly, every other pixel, e.g., pixel 302 and pixel 310, is separated from an adjacent pixel, e.g., pixel 309 and pixel 310, by the greater predetermined distance, i.e., predetermined distance 337, while the remaining pixels, e.g., pixel 309 and pixel 310, are spaced by the shorter predetermined distance, i.e., predetermined distance 336. This can be repeated. As such, moving left to right, every odd pixel can be separated from its even pixel neighbor by predetermined distance 337, while every even pixel is separated from its odd pixel neighbor by predetermined distance 336. Of course, the opposite can be true. Moving top to bottom, every odd pixel can be separated from its even pixel neighbor by predetermined distance 341, while every even pixel is separated from its odd pixel neighbor by predetermined distance 341. Combinations of the two can also be used.

While every other pixels is one explanatory application for the inclusion of predetermined distance 337, it will be obvious to those of ordinary skill in the art having the benefit of this disclosure that embodiments of the invention are not so limited. As one example, the predetermined distance 337 could be inserted between every pixel. Accordingly, subpixel 305 would be spaced apart from subpixel 306 by predetermined distance 337, as would subpixel 308 from subpixel 311. Similarly, subpixel 313 could be spaced apart from subpixel 314 as shown. This every pixel spacing could be applied vertically as well, with subpixel 333 being substituted for the leftmost subpixel of pixel 331 by predetermined distance 341. Other examples will be obvious to those of ordinary skill in the art having the benefit of this disclosure.

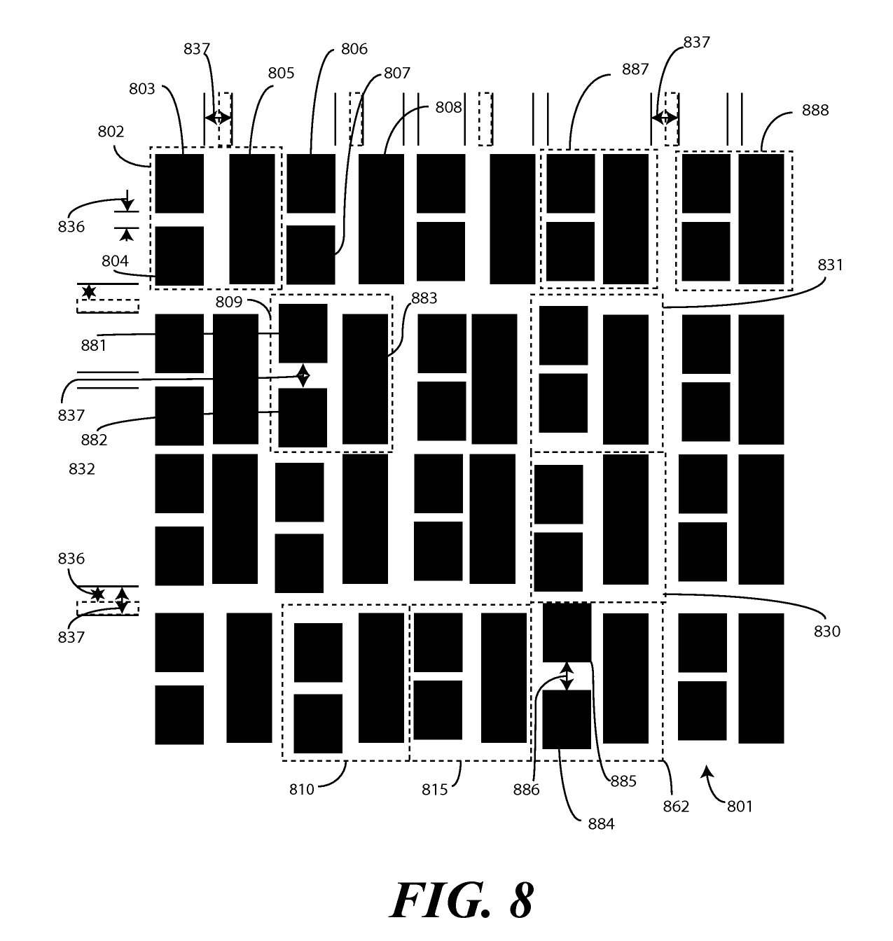

As shown in FIG. 3, the larger spacing of predetermined distance 337 is applied “inter-pixel,” which means that a first pixel comprises the at least one subpixel and a second pixel comprises the at least one adjacent subpixel and the first pixel and adjacent pixel have the greater spacing therebetween. In FIG. 3 for example, the last subpixel 305 of pixel 302 is separated from the first subpixel 306 of pixel 309 by predetermined distance 337, while each subpixel 303,304,305 of pixel 302 is spaced apart from each other subpixel 303,304,305 of pixel 302 by predetermined distance 336. The same is true of pixel 309 (and the remaining pixels of the display device 301). Each subpixel 306,307,308 of pixel 309 is spaced apart from each other subpixel 306,307,308 of pixel 309 by predetermined distance 336. However, this is just but one embodiment. In another embodiment that will be described with reference to FIG. 8 below, the larger spacing can be applied “intra-pixel” with spacing between some subpixels of a given pixel having the greater spacing and other spacings between other subpixels having the lesser spacing. In one or more embodiments, this can be achieved without violating the characteristic of every pixel having at least two subpixels spaced apart from each other by a predefined spacing and one or more pixels comprising a subportion of the plurality of pixels each having at least one subpixel spaced apart from at least one adjacent subpixel by another predefined spacing that is greater than the predefined spacing. It is just that in this latter scenario a single pixel will comprise both the at least one subpixel and the at least one adjacent subpixel. By contrast, in the embodiment of FIG. 3 one pixel comprises the at least one subpixel and another pixel comprises the at least one adjacent subpixel.

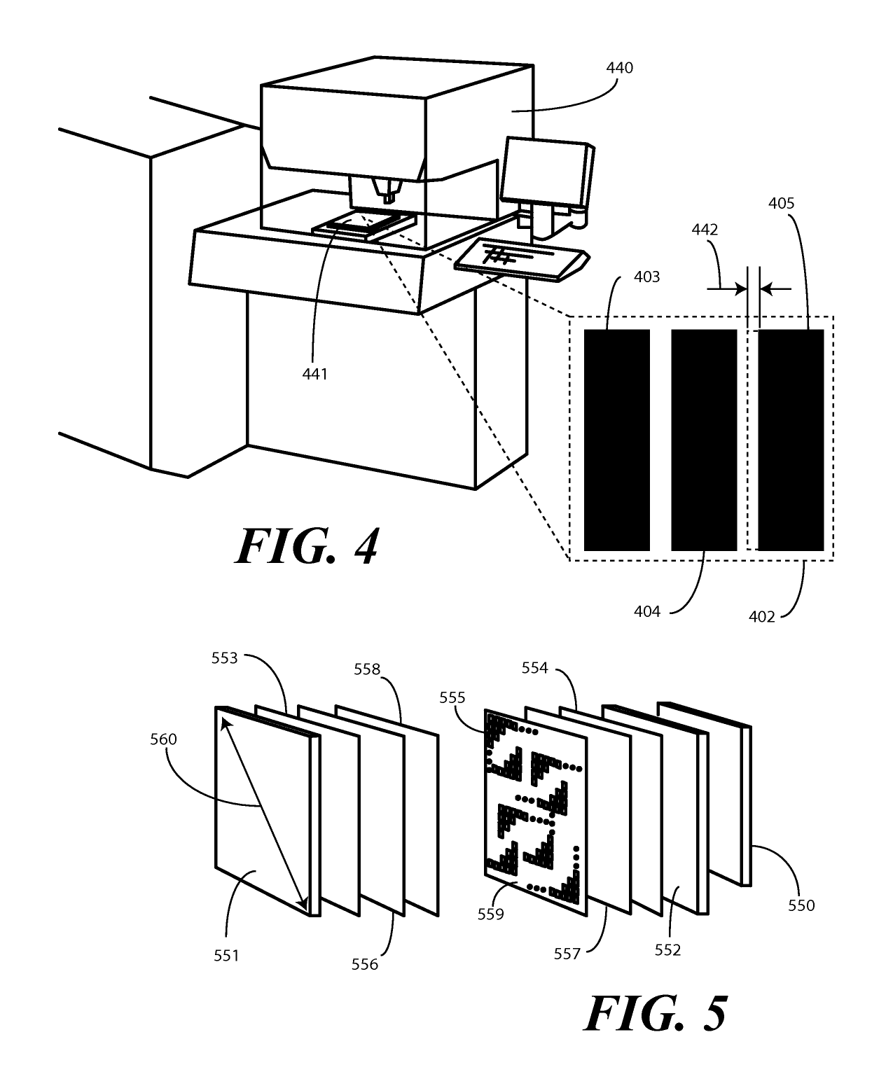

Turning now to FIG. 4, illustrated therein is a placement machine 440 configured to manufacture, in accordance with methods described herein, a display module configured in accordance with one or more embodiments of the invention. The term “placement machine” is used herein to refer to a machine capable of placing, depositing, printing, or otherwise configuring subpixels 403,404,405, or components thereof, including drive transistors, capacitors, and so forth, on a substrate 441 to form one or more pixels, e.g., pixel 402. It should be understood while one placement machine 440 is shown in FIG. 4 for illustration, the placement machine 440 is representative of one or more placement machines, processes, or other equipment used in making a display.

The placement machine 440 forms the subpixels 403,404,405 by forming electrodes along a transparent substrate 441. Such electrodes can be formed from a transparent electrode material, such as by the disposition of indium-tin oxide on the substrate 441. The transparent electrode patterns can be made by applying a layer of indium tin oxide to the substrate 441 and using a photolithography or silk-screening process to produce the desired subpixel pattern. Thin film transistors and capacitors can be formed, with the transistors being used to drive each subpixel 403,404,405. The capacitors can store a charge sufficient to induce the electric field along the transparent electrode, while the thin film transistors regulate when the capacitor charges and discharges.

Accordingly, the placement machine can be configured to deposit electrodes, wiring layers, and other materials along the substrate 441. Insulating films can be used to isolate gates of transistors and can be formed using silicon dioxide or other materials. Planarizing film can be applied to isolate wiring layers. Photosensitive resins can then be used to complete the construction of each subpixel 403,404,405.

In one or more embodiments, the placement machine 440 includes an inherent placement limitation. Said differently, due to the physical components required for each subpixel 403,404,405 being disposed along the substrate 441, combined with the technology available to the placement machine 440, there is a predefined minimum placement spacing dimension 442 associated with the subpixel construction. This represents the minimum distance that a subpixel, e.g., subpixel 405, can be moved and still be accurately placed. Accordingly, if a subpixel 405 can be placed at coordinates X,Y, the next closest place along the horizontal that the same subpixel 405 can be placed is X+predefined minimum placement spacing dimension 442, Y, because the predefined minimum placement spacing dimension 442 represents a minimum placement resolution. Similarly, using coordinate X,Y as a reference, the next closest place along the vertical that that the same subpixel can be placed is X,Y+the predefined minimum placement spacing dimension 442. Of course, the subpixel can be moved both horizontally and vertically.

In one explanatory embodiment, the predefined minimum placement spacing dimension 442 is 0.25 micrometers. In accordance with one or more embodiments of the invention, the predetermined distance (337) is set to the predefined minimum placement spacing dimension 442. Accordingly, the predetermined distance (337), in one embodiment, is set to 0.25 micrometers. This spacing can be advantageous in certain applications. For example, as noted above, in an electronic device application where a housing will only permit a display device having a diagonal dimension of 4.975 inches, setting the predetermined distance (337) to 0.25 micrometers for a display having 720 columns of pixels and 1280 rows of pixels and inserting the predetermined distance (337) between every other pixel (302,309, results in the diagonal dimension of 4.944 inches, which cannot be marketed as a “5-inch display” to increase to 4.97. This increase allows the display to be marketed as a “5-inch” display while still fitting within the 4.975-inch housing dimension. Another advantage of using 0.25 micrometers as the predetermined distance (337) is that no visible artifacts are introduced by the inclusion of the predetermined distance (337) between some of the pixels.

Note that while using the predefined minimum placement spacing dimension 442, be it 0.25 micrometers or another dimension, is one suitable predetermined distance (337), any number of other predetermined spacings can be used without departing from the spirit and scope of the invention. Numerous others will be obvious to those of ordinary skill having the benefit of this disclosure.

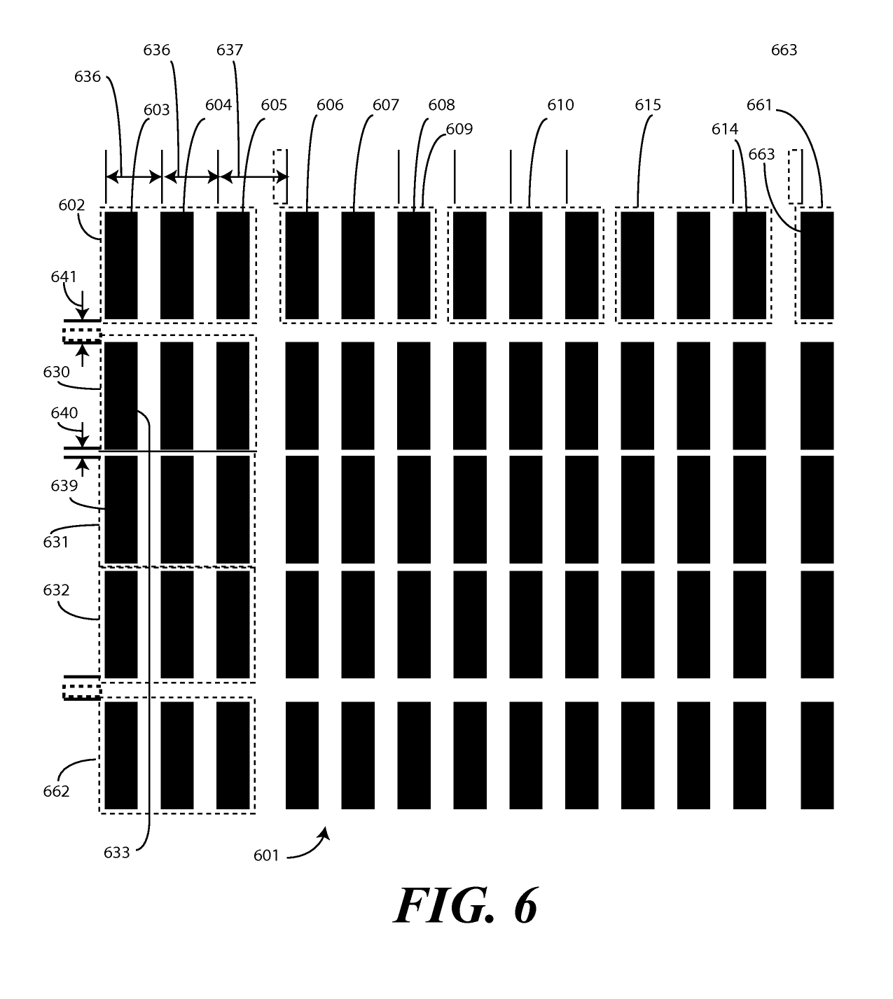

Turning now to FIG. 6, illustrated therein is one explanatory display module 502 configured in accordance with one or more embodiments of the invention that can be constructed by the placement machine (440) and its corresponding processes of FIG. 4. The illustrative display module 502 of FIG. 6 is a liquid crystal display, those of ordinary skill in the art having the benefit of this disclosure will find other types of displays obvious as well.

As shown in FIG. 6, the display module 502 includes a front glass layer 551 and a rear glass layer 552. These glass layers 551,552 can form the substrate (441) described above and can be coated with the electrodes that form the subpixels (403,404,405) of each pixel (402). The electrodes can be formed from layers 556,557 of indium-tin oxide. Drive electronics and control electronics can also be disposed along the glass layers 551,552. Layers 553,554 of silicon dioxide can be disposed between the glass layers 551,552 to improve alignment of the liquid crystal material that is disposed in the liquid crystal layer 555. Layers 558,559 of polymer can be included to retain the liquid crystal layer 555 between the glass layers 551,552. Polarizing layers (not shown) can be included as well.

In one embodiment, the display module 502 comprises a 720 pixel by 1280 pixel display module has a diagonal dimension 560 of between 4.95 inches and 4.97 inches, inclusive. In one embodiment, a light source 550 or backlight can be included to emit light through the various layers. The light source 550 can be a light emitting diode light source, a fluorescent light source, an organic light emitting diode light source, or other type of light source. Where an organic light emitting diode light source is used, the subpixels (403,404,405) can be referred to as organic light emitting diode subpixels.

Turning now to FIG. 6, illustrated therein is an alternate display device 601 configured in accordance with one or more embodiments of the present invention. Recall from above that the display device (301) of FIG. 3 employed the greater predetermined distance (337) between every other pixel (302,309). FIG. 6 illustrates that embodiments of the invention are not so limited by showing another explanatory embodiment of how a non-uniform, asymmetric subpixel spacing that does not result in any visual artifacts but that allows one or more major dimensions of the display device 301 to be increased by a predetermined amount can be achieved.

As shown in FIG. 6, the display device 601 comprises a plurality of pixels. As with FIG. 3 above, the pixels are grouped in rows and columns. Illustrating by example, pixels 602,609,610,615,630,631,632,662 are shown. Each of the pixels 602,609,610,615,630,631,632,662 comprises a plurality of subpixels. For instance, pixel 602 comprises subpixels 603,604,605. Similarly, pixel 609 comprises subpixels 606,607,608, and so forth.

Each of the pixels 602,609,610,615,630,631,632,662 has at least two subpixels that are spaced apart from each other by a predetermined spacing. Illustrating by example, subpixel 603 and subpixel 604 are spaced apart from each other by a predetermined spacing 636 or distance. Similarly, subpixel 604 is spaced apart from subpixel 605 by the predetermined spacing 636. This continues for each pixel 602,609,610,615,630,631,632,662, as every pixel can be found to have at least two subpixels spaced apart from each other by the predetermined spacing 636.

To provide the asymmetric, non-uniform spacing, one or more of the pixels, which collectively comprise a subportion of the total number of pixels on the display device 601, have at least one subpixel that is spaced apart from at least one adjacent subpixel by another predetermined distance or spacing that is greater than predetermined spacing 636. In one embodiment, this greater predetermined spacing 637 comprises the predetermined spacing 636 plus the predefined minimum placement spacing dimension (442) of a placement machine (440) used to construct the display device 601. As one example, subpixel 605 is spaced apart from subpixel 606 by predetermined spacing 637. Looking at the spacing between the rows, adjacent subpixels, e.g., subpixels 633,639, are spaced apart by predetermined distance 640. This predetermined distance 640 can be the same as predetermined spacing 636. However in one embodiment, predetermined distance 640 is less than predetermined spacing 636. In another embodiment, predetermined distance 640 is greater than predetermined spacing 636.

While some subpixels are spaced apart vertically by predetermined distance 640, others are spaced apart by predetermined distance 641, which is greater than predetermined distance 640. This predetermined distance 641 can be the same as predetermined distance 337. However in one embodiment, predetermined distance 641 is less than predetermined spacing 637. In another embodiment, predetermined distance 641 is greater than predetermined spacing 637. As with the embodiment of FIG. 3, spacing can be only provided across the horizontal or only along the vertical. However, a combination of varied vertical and horizontal spacing can also be used.

Rather than including predetermined spacing 637 to separate every other pixel of the plurality of pixels, as was the case in FIG. 3, the embodiment of FIG. 6 uses a “1-3” spacing, both along the vertical and across the horizontal. For example, as shown, pixel 602 has a subpixel 605 spaced apart by predetermined spacing 637 from a subpixel 606 of pixel 609. The next three pixels 609,610,615 each employ predetermined spacing 636 between their respective subpixels. However, subpixel 614 of pixel 615 is spaced from subpixel 663 of pixel 661 by predetermined spacing 637. Accordingly, one pixel 602 is spaced from an adjacent pixel 609 by predetermined spacing 637, while the next three pixels 609,610,615 are spaced by predetermined spacing 636, thereby forming the “1-3” spacing arrangement. The same arrangement is followed along the vertical, as is shown in FIG. 6. As with FIG. 3, the spacing in FIG. 6 is applied on an “inter-pixel” basis.

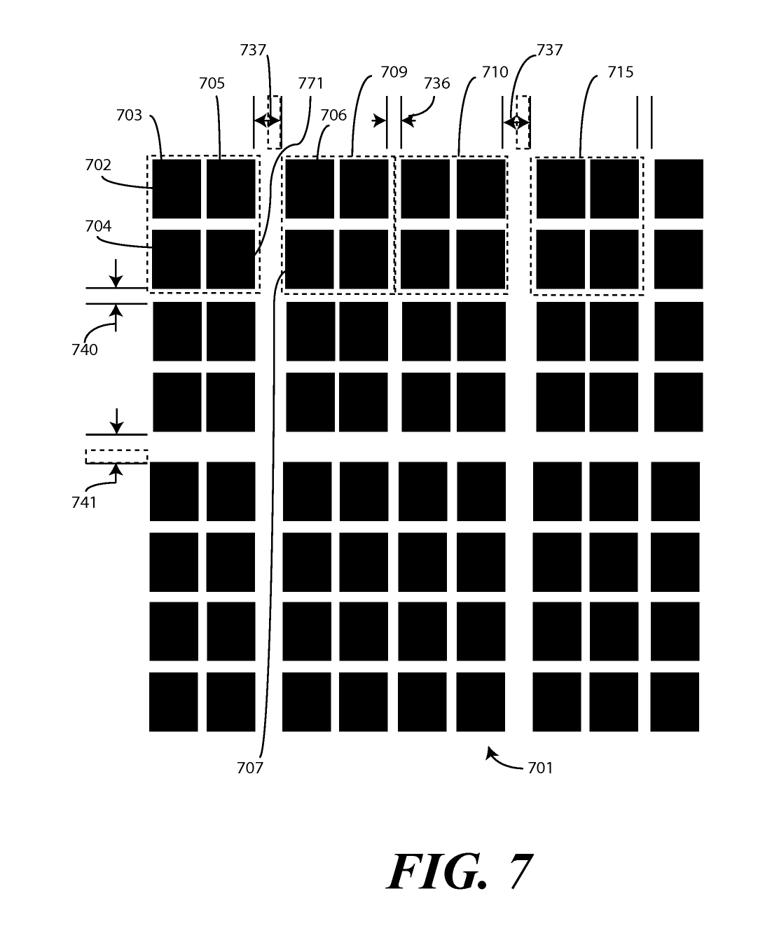

Turning now to FIG. 7, illustrated therein is another display device 701 configured in accordance with one or more embodiments of the present invention. While the display device (301) of FIG. 3 and the display device (601) of FIG. 6 each employed three subpixels per pixel, the display device 701 of FIG. 7 employs four subpixels per pixel.

Illustrating by example, pixel 702 included four subpixels 703,704,705,771. These subpixels 703,704,705,706 comprise a red subpixel, blue subpixel, green subpixel, and yellow subpixel in one embodiment. As with the display device (301) of FIG. 3, a greater spacing, i.e., predetermined spacing 737, is included on an inter-pixel basis between every other pixel. Thus, pixel 702 has a subpixels 705,771 spaced apart by predetermined spacing 737 from subpixels 706,707 of pixel 709. Similarly, pixel 710 has its subpixels spaced apart from the subpixels of pixel 715 by predetermined spacing 737. By contrast, pixel 709 has its subpixels spaced apart from the subpixels of pixel 710 by a shorter predefined spacing, i.e., predetermined spacing 736. Accordingly, every other pixel, e.g., pixel 702 and pixel 710, is separated from an adjacent pixel, e.g., pixel 709 and pixel 710, by the greater predetermined distance, i.e., predetermined spacing 737, while the remaining pixels, e.g., pixel 709 and pixel 710, are spaced by the shorter predetermined distance, i.e., predetermined spacing 736. This can be repeated. As such, moving left to right, every odd pixel can be separated from its even pixel neighbor by predetermined spacing 737, while every even pixel is separated from its odd pixel neighbor by predetermined spacing 736. Of course, the opposite can be true. Moving top to bottom, every odd pixel can be separated from its even pixel neighbor by predetermined distance 741, while every even pixel is separated from its odd pixel neighbor by predetermined distance 740. Combinations of the two can also be used.

Turning now to FIG. 8, illustrated therein is yet another display device 801 configured in accordance with one or more embodiments of the present invention. Each of the display devices (301,601,701) described above have been asymmetrical due to a greater spacing being included between subportions of the pixels on an inter-pixel basis. The display device 801 illustrates including a greater spacing on an intra-pixel basis. As combinations of inter-pixel and intra-pixel spacing can be used, the explanatory display device 801 of FIG. 8 employs both.

As shown in FIG. 8, the display device 801 comprises a plurality of pixels. As with other embodiments described above, the pixels are grouped in rows and columns. Illustrating by example, pixels 802,809,810,815,862,830,831,832 are shown. Each of the pixels 802,809,810,815,862,830,831,832 comprises a plurality of subpixels. For instance, pixel 802 comprises subpixels 803,804,805. Similarly, pixel 809 comprises subpixels 806,807,808, and so forth.

Note that in FIG. 8, some of the subpixels are larger than some others of the pixels. For example, within pixel 802, subpixel 805 is larger than subpixels 803,804. This can be the case for a variety of reasons. In one embodiment, subpixel 805 comprises a blue subpixel. As blue light is more challenging to generate, it can be advantageous to make the blue subpixel larger than the others. Those of ordinary skill in the art having the benefit of this disclosure will find it obvious to make some subpixels larger than others for other reasons. While the intra-pixel spacing of FIG. 8 is being used in this explanatory configuration, it should be noted that the intra-pixel spacing can be used when the subpixels are all the same size as well.

As with previous embodiments, each of the pixels 802,809,810,815,862,830,831,832 has at least two subpixels that are spaced apart from each other by a predetermined spacing. Illustrating by example, subpixel 803 and subpixel 804 are spaced apart from each vertically other by a predetermined spacing 836. This continues for each pixel 802,809,810,815,862,830,831,832, as every pixel can be found to have at least two subpixels spaced apart from each other by the predetermined spacing 836.

To provide the asymmetric, non-uniform spacing, one or more of the pixels, which collectively comprise a subportion of the total number of pixels on the display device 801, have at least one subpixel that is spaced apart from at least one adjacent subpixel by another predetermined distance or spacing that is greater than predetermined spacing 836. This is done both on an intra-pixel basis and an inter-pixel basis

As one example of intra-pixel spacing, subpixel 805 is spaced apart from subpixels 803,804, within pixel 802, by predetermined distance 837. Similarly, in pixel 832, subpixel 881 is spaced apart from subpixel 882 by predetermined distance 837. In pixel 862, subpixels 884,885 are separated by a second distance 886, the second distance 886 being even greater than predetermined distance 837. An example of inter-pixel spacing occurs between pixel 887 and pixel 888, whose adjacent subpixels are spaced apart by predetermined distance 837.

In addition to inter-pixel spacing and intra-pixel spacing, other illustrative “shifting” of pixels can occur. In pixel 810, the two smaller subpixels have been spaced down vertically from the pixel thereabove by predetermined distance 837, while the larger subpixel is spaced down vertically from the pixel thereabove by only predetermined spacing 836. The opposite is occurring in pixel 831. In pixel 830, the larger subpixel is spaced upward vertically by the greater distance, while the two smaller ones are spaced upward vertically by the lesser distance.

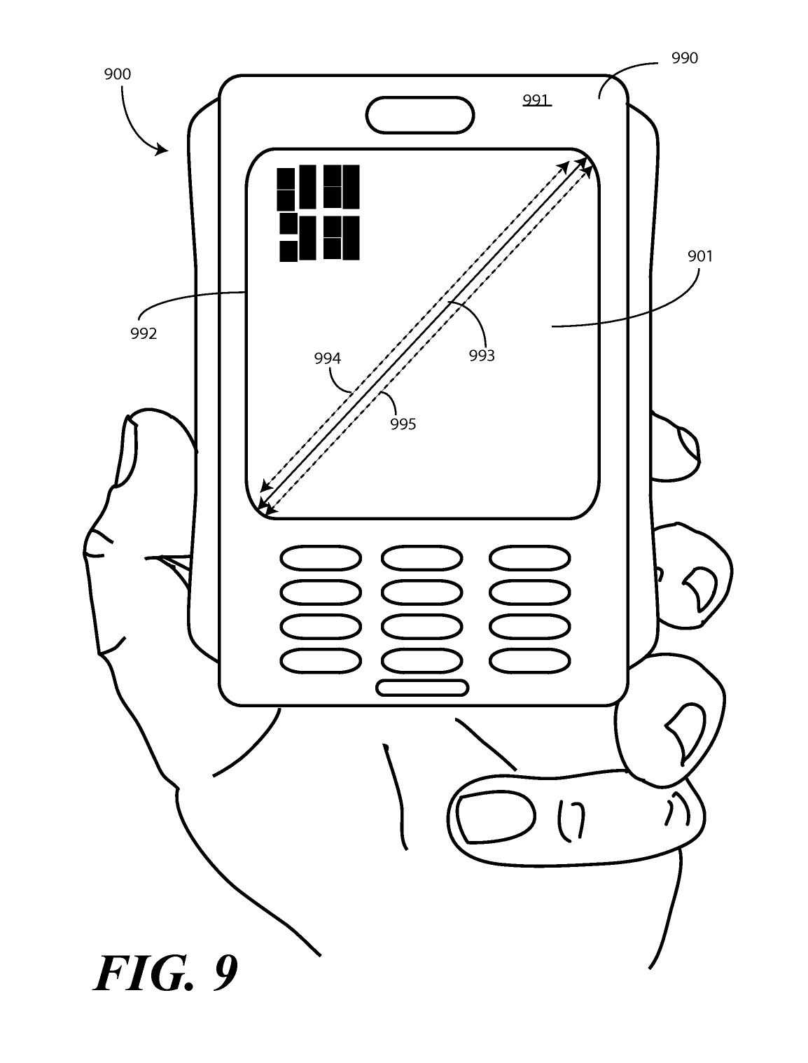

Turning now to FIG. 9, illustrated therein is an electronic device 990 having a housing 991 with an aperture 992 disposed therein and a display module 901 configured in accordance with one or more embodiments of the invention disposed within the housing 991. As shown, the display module 901 can be seen through the aperture 992 in the housing 991 of the electronic device 990.

The embodiment of FIG. 9 provides an illustration of one explanatory benefit afforded by embodiments of the present invention. The aperture 992 has a diagonal dimension 993 of 4.975 inches. Employing a uniform spacing on state of the art placement equipment, a display having 720 columns of pixels and 1280 rows of pixels has a diagonal dimension 994 of 4.944 inches. In accordance with the commonly accepted marketing practices described above, this display cannot be marketed as a “5-inch display” because, rounding to the nearest tenth of an inch, it is only a 4.9 inch display. Using the next available prior art design, the diagonal dimension of the display increases to 4.987 inches, which is too wide to be seen in its entirety through the aperture 992. When the display module 901 is configured in accordance with one or more of the embodiments described above, i.e., by using the non-uniform spacing of only some of the subpixels of the display as previously described, a designer can increase the original diagonal dimension 994 to an expanded diagonal dimension 995 of, for example, 4.97 inches without any visible artifacts. This expanded diagonal dimension 995 can both be seen in its entirety through the aperture 992 of the housing 991 while still being able to be marketed as a 5-inch display in the marketplace.

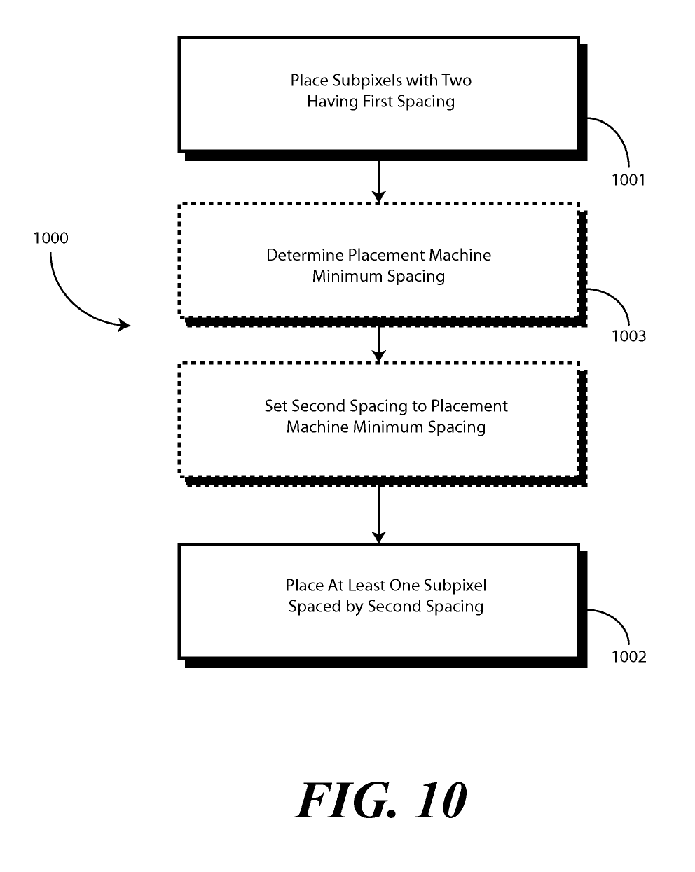

Turning now to FIG. 10, illustrated therein is one explanatory method 1000 of placing pixels on a substrate to define a pixel array for a display module in accordance with one or more embodiments of the invention. Many of the method steps have largely been described above with reference to the apparatus components. Accordingly, they will be described with brevity where appropriate in the discussion of FIG. 10.

The primary steps of the method are steps 1001 and 1002. Beginning at step 1001, the method 1000 includes placing all pixels such that at least two subpixels of each pixel are separated by a predefined distance. In one embodiment, step 1001 includes placing the pixels in columns and rows. Accordingly, the display module will include pixels arranged in a predetermined number of rows and a predetermined number of columns

Step 1002 of the method 1000 includes placing some of the pixels such that at least one subpixel is separated from at least one adjacent subpixel by a distance greater than the predefined distance. Step 1002 can include spacing some of the predetermined number of rows farther apart from adjacent rows than some others of the predetermined number of rows. This step 1002 can include spacing subpixels where the at least one subpixel is spaced from at least one adjacent subpixel belonging to a different pixel by the greater distance. The result of this step 1002, in one embodiment, is that the pixel array has a non-uniform pixel pitch.

How many constitutes “some” of the pixels will vary based upon application. In one embodiment, “some” includes every other pixel. In other embodiments, “some” includes that number resulting in a 1-3 spacing. In other embodiments, only selected pixels will be spaced by the greater distance, as was described with reference to FIG. 8 above.

In one embodiment, optional step 1003 can include determining a minimum placement accuracy of a placement machine placing the pixels on the substrate. Where this optional step 1003 is included, in one embodiment the method 1000 includes making the distance greater than the predefined distance by the minimum placement accuracy. As described above, one minimum placement accuracy of state of the art equipment at the time of filing of the present application is 0.25 um.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. A display module comprising a plurality of pixels operable to emit or modulate light, with each pixel of the plurality of pixels comprising a plurality of subpixels, wherein:
every pixel comprises at least two subpixels spaced apart from each other by a predefined spacing;
one or more pixels comprising a subportion of the plurality of pixels each comprise at least one subpixel spaced apart from at least one adjacent subpixel by another predefined spacing; and
the another predefined spacing is greater than the predefined spacing.

2. The display module of claim 1, wherein the one or more pixels comprising the subportion of the plurality of pixels comprises at least every other pixel of the plurality of pixels.

3. The display module of claim 2, wherein the at least every other pixel of the plurality of pixels comprises odd pixels of the plurality of pixels.

4. The display module of claim 1, wherein the plurality of subpixels are disposed along a substrate of the display module by a placement machine, wherein the another predefined spacing comprises a minimum placement spacing of the placement machine.

5. The display module of claim 1, wherein the another predefined spacing is applied on an intra-pixel basis.

6. The display module of claim 1, wherein a first pixel comprises the at least one subpixel and a second pixel comprises the at least one adjacent subpixel.

7. The display module of claim 1, wherein a single pixel comprises both the at least one subpixel and the at least one adjacent subpixel.

8. The display module of claim 1, wherein the plurality of pixels define a resolution of a pixel display module.

9. The display module of claim 8, wherein the display module has a diagonal dimension that, when measured in hundreths of inches, rounds to a multiple of one hundred inches.

10. The display module of claim 1, wherein the plurality of subpixels comprise one of three subpixels or four subpixels.

11. The display module of claim 1, wherein the plurality of subpixels comprises either light modulating pixels or light emitting pixels.

12. The display module of claim 1, wherein some subpixels are larger than some other subpixels.

13. A method of placing pixels on a substrate to define a pixel array for a display module, the method comprising:
placing all pixels such that at least two subpixels are separated by a predefined distance; and
placing some of the pixels such that at least one subpixel is separated from at least one adjacent subpixel by a distance greater than the predefined distance.

14. The method of claim 13, further comprising determining a minimum placement accuracy of a placement machine placing the pixels on the substrate.

15. The method of claim 14, wherein the distance is greater than the predefined distance by the minimum placement accuracy.

16. The method of claim 15, wherein the minimum placement accuracy is applied on an inter-pixel basis.

17. The method of claim 15, wherein the pixels comprise a predetermined number of rows and a predetermined number of columns.

18. The method of claim 17, further comprising spacing some of the predetermined number of rows farther apart from adjacent rows than some others of the predetermined number of rows.

19. The method of claim 13, wherein the at least one subpixel and the at least one adjacent subpixel belong to different pixels.

20. The method of claim 13, wherein the placing some of the pixels results in the pixel array having a non-uniform pixel pitch.
